(19) United States
(12) Patent Application Publication
(10) Pub. No.: US 2025/0100449 A1
(43) Pub. Date: Mar. 27, 2025

(54) SENSOR MOUNTING STRUCTURE FOR A VEHICLE

(71) Applicant: International Truck Intellectual Property Company, LLC, Lisle, IL (US)

(72) Inventor: Robert M. Tourville, Aurora, IL (US)

(73) Assignee: International Truck Intellectual Property Company, LLC, Lisle, IL (US)

(21) Appl. No.: 18/371,139

(22) Filed: Sep. 21, 2023

(51) Int. Cl. B60R 1/08; B60R 1/062; B60R 1/12; G01S 13/931; G01S 17/931

(52) U.S. Cl. CPC B60R 1/08; B60R 1/062; B60R 1/12; G01S 13/931; G01S 17/931; B60R 2001/1223; G01S 2013/9327

(57) ABSTRACT

A sensor mounting structure for a vehicle includes a support arm that extends at a first end from the vehicle body, and a sensor assembly attached to a second end of the support arm. The sensor assembly includes at least one mirror having a back side and a reflective side facing a first direction, and at least one sensor.

### FIELD OF THE INVENTION

The present disclosure relates generally to a sensor mounting structure for a vehicle, and more particularly to a sensor mounting structure for a vehicle that is built into an existing side view mirror structure and that can be configured for both manual driving and autonomous driving.

### BACKGROUND

Sensors are being disposed on surfaces of modern vehicles in ever increasing numbers. Such sensors are distributed all around a vehicle for collecting data on the vehicle surroundings in all directions for use in critical tasks, for example, including autonomous driving modes. In some instances, such sensors are added to a vehicle mounted on a winglet or other body extension from the surface, which takes away from the aesthetics of the vehicle and can result in an odd and/or cluttered look. Additional winglets or body extensions add complexity and cost to manufacture as well. A need therefore exists for a sensor mounting system that utilizes existing structures without having to add structures. It would be useful if such a mounting system could be added to existing structures without limiting or decreasing their existing functionality, for example, if such a mounting system could seamlessly accommodate both manual driving using mirrors without sensors and autonomous driving using sensors without mirrors.

### SUMMARY OF THE INVENTION

In one aspect of the invention, a sensor mounting structure for a vehicle comprises a support arm that extends at a first end from the vehicle body, and a sensor assembly attached to a second end of the support arm. The sensor assembly comprises at least one mirror having a back side and a reflective side facing a first direction, and at least one sensor.

In another aspect of the invention, a sensor mounting structure for a vehicle comprises a support arm that extends at a first end from the vehicle body, and a sensor assembly attached to a second end of the support arm. The sensor assembly comprises at least one mirror having a back side and a reflective side facing a first direction, and at least one sensor. In a first configuration the at least one sensor is disposed having a field of view directed to the first direction and the back side of the at least one mirror disposed with the reflective side facing the first direction, and in a second configuration the at least one mirror is disposed outside of the field of view of the at least one sensor disposed having a field of view directed to the first direction.

In a further aspect of the invention, a sensor mounting structure for a vehicle comprises a support arm that extends at a first end from the vehicle body, and a sensor assembly attached to a second end of the support arm. The sensor assembly comprises a plurality of mirrors each having a back side and a reflective side facing a first direction, and at least one sensor. In a first configuration the at least one sensor is disposed having a field of view directed to the first direction and the back side of at least one of the plurality of mirrors disposed with the reflective side facing the first direction, and in a second configuration the at least one of the plurality of mirrors is disposed outside of the field of view of the at least one sensor disposed having a field of view directed to the first direction.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram of a vehicle body having a conventional side-view mirror assembly;

FIG. 2 is a schematic diagram of an exemplary sensor mounting structure according to an embodiment;

FIG. 3 is a schematic diagram of an exemplary sensor assembly according to an embodiment;

FIG. 4A is a schematic diagram of an exemplary sensor assembly in a second configuration according to an embodiment; and

FIG. 4B is a schematic diagram of an exemplary sensor assembly in a first configuration according to an embodiment.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

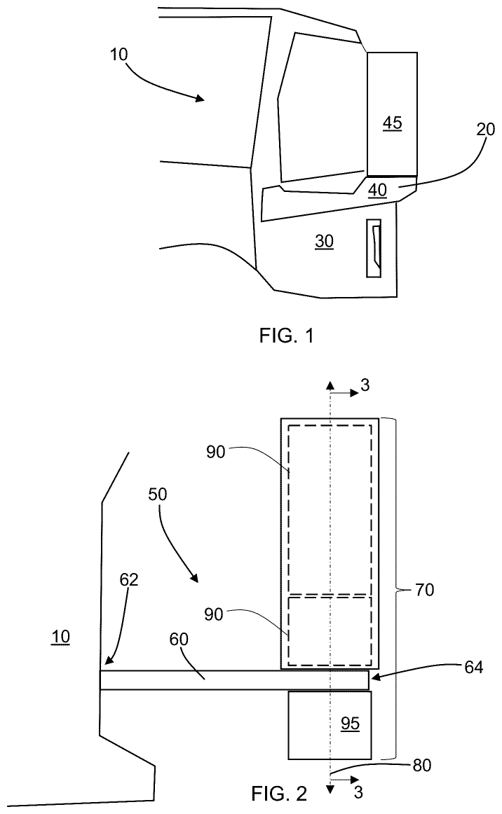

Referring to FIG. 1, an exemplary vehicle body 10 is illustrated having an exemplary side-view mirror assembly 20 extending from a door 30 of the body 10. The exemplary side-view mirror assembly 20 comprises a support mirror arm 40 and a mirror 45.

Referring to FIG. 2, in an embodiment, a sensor mounting structure 50 comprises a support arm 60 and a sensor assembly 70. In an embodiment the support arm 60 extends at a first end 62 from a vehicle body 10. In an embodiment the sensor assembly 70 attaches to a second end 64 of the support arm 60. In an embodiment the sensor assembly includes an axis 80 disposed therethrough.

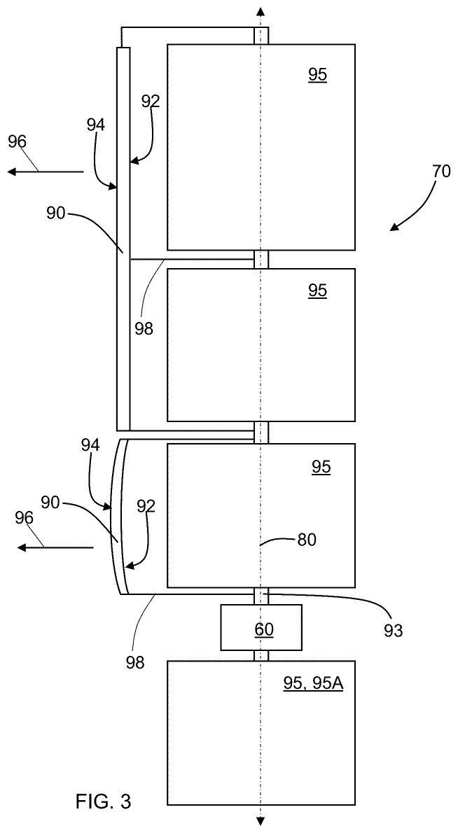

Referring to FIG. 3, in an embodiment the sensor assembly 70 comprises at least one mirror 90 (two are shown) and at least one sensor 95 (four are shown). In an embodiment each of the mirrors 90 has a back side 92 and a reflective side 94 facing in a first direction 96. In an embodiment, each of the mirrors 90 can be flat or convex, for example, flat as illustrated by the top mirror in FIG. 3, or convex (in the first direction 96) as illustrated by the bottom mirror 90 in FIG. 3.

In an embodiment, one or more of the sensors 95, also referred to as an additional sensor 95A, may be positioned along the axis 80 so as to never be configured behind a mirror 90, for example like the bottom sensor 95 shown in FIG. 3. In an embodiment, each of the sensors 95, 95A can have a field of view directed to the first direction 96 or to a direction different from the first direction 96. In an embodiment each of the sensors 95, 95A is selected from the group of sensors consisting of an optical sensor, a light direction and ranging (LIDAR) sensor, a radio detection and ranging (RADAR) sensor, an infrared sensor, and a sonic sensor.

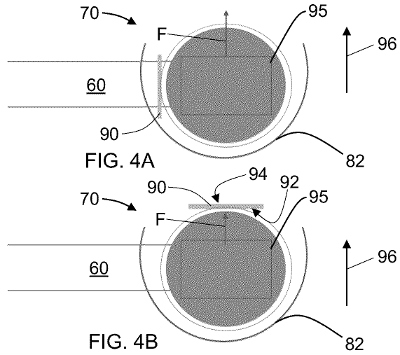

Referring to FIGS. 3 to 4B, in an embodiment, each of the sensors 95, 95A is fixed relative to the axis 80. In another embodiment each of the mirrors 90 and each of the sensors 95, 95A is configured to be controllably rotated around the axis 80 from the first configuration (shown in FIG. 4B) to the second configuration (shown in FIG. 4A). Referring to FIGS. 4A and 4B, the sensor assembly 70 is schematically illustrated as viewed from above along the axis 80. In an embodiment a windscreen 82 protects the components of the sensor assembly 70 from wind and debris as the vehicle upon which it is mounted drives along.

In an embodiment the sensor assembly 70 has first and second configurations. In a first configuration as exemplarily shown in FIG. 4B the at least one sensor 95 is disposed having a field of view, F, directed to the first direction 96 and the back side 92 of the at least one mirror 90 disposed with the reflective side 94 facing the first direction 96. In a second configuration as exemplarily shown in FIG. 4A the at least one mirror 90 is disposed outside of the field of view, F, of the at least one sensor 95 disposed having the field of view, F, directed to the first direction 96.

In another embodiment each of the mirrors 90 and each of the sensors 95, 95A is configured to be controllably rotated around the axis 80 from the first configuration (shown in FIG. 4B) to the second configuration (shown in FIG. 4A). For example, in an embodiment each of the sensors 95, 95A and mirrors 90 is attached to a drive shaft 93, and portions of the drive shaft 93 to which each sensor 95, 95A or mirror 90 is attached can be independently rotated, for example by a motor and transmission assembly (not shown), as directed from the driver console within the vehicle body 10. Thus, the sensor assembly 70 can be configured for both manual driving using the mirrors 90 or for autonomous driving using the sensors 95, 95A with the mirrors 90 moved, for example rotated, out of the field of view, F, of the sensors 95, 95A.

In an embodiment each of the sensors 95, 95A are illustrated in FIG. 3 to be attached directly to the drive shaft 93, whereas the mirrors 90 are illustrated to be attached by supporting members 98. In other embodiments other mechanisms can be used to facilitate movement of the mirrors 90 and the sensors 95, 95A around the axis 80.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

A sensor mounting structure for a vehicle includes a sensor assembly having at least one mirror and at least one sensor. The sensor assembly can be configured for both manual driving using the at least one mirror or for autonomous driving using the at least one sensor with the mirrors moved out of the field of view of the at least one sensor. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A sensor mounting structure for a vehicle, the structure comprising:
a support arm that extends at a first end from the vehicle body; and
a sensor assembly attached to a second end of the support arm, wherein the sensor assembly comprises:
at least one mirror having a back side and a reflective side facing a first direction; and
at least one sensor.

2. The sensor mounting structure of claim 1, wherein the at least one sensor has a field of view directed to the first direction.

3. The sensor mounting structure of claim 1, wherein the at least one sensor has a field of view directed to a direction different from the first direction.

4. The sensor mounting structure of claim 1, wherein the at least one sensor comprises a plurality of sensors that each has a field of view directed to either the first direction or a different direction.

5. The sensor mounting structure of claim 1, wherein the plurality of sensors is selected from the group of sensors consisting of an optical sensor, a light direction and ranging (LIDAR) sensor, a radio detection and ranging (RADAR) sensor, an infrared sensor, and a sonic sensor.

6. The sensor mounting structure of claim 1, wherein
in a first configuration the at least one sensor is disposed having a field of view directed to the first direction and the back side of the at least one mirror disposed with the reflective side facing the first direction, and
in a second configuration the at least one mirror is disposed outside of the field of view of the at least one sensor disposed having a field of view directed to the first direction.

7. The sensor mounting structure of claim 6, wherein the at least one mirror is disposed to rotate around an axis disposed through the sensor assembly from the first configuration to the second configuration.

8. The sensor mounting structure of claim 6, wherein the at least one mirror comprises a flat mirror and a convex mirror.

9. The sensor mounting structure of claim 6, further comprising at least an additional sensor having a field of view directed to a direction different from the first direction.

10. A sensor mounting structure for a vehicle, the structure comprising:
a support arm that extends at a first end from the vehicle body; and
a sensor assembly attached to a second end of the support arm, wherein the sensor assembly comprises:
at least one mirror having a back side and a reflective side facing a first direction; and
at least one sensor; wherein
in a first configuration the at least one sensor is disposed having a field of view directed to the first direction and the back side of the at least one mirror disposed with the reflective side facing the first direction, and
in a second configuration the at least one mirror is disposed outside of the field of view of the at least one sensor disposed having a field of view directed to the first direction.

11. The sensor mounting structure of claim 10, wherein the at least one mirror is disposed to rotate around an axis disposed through the sensor assembly from the first configuration to the second configuration.

12. The sensor mounting structure of claim 10, wherein the at least one mirror comprises a flat mirror and a convex mirror.

13. The sensor mounting structure of claim 10, wherein the at least one sensor comprises a plurality of sensors, and wherein the plurality of sensors is selected from the group of sensors consisting of an optical sensor, a light direction and ranging (LIDAR) sensor, a radio detection and ranging (RADAR) sensor, an infrared sensor, and a sonic sensor.

14. The sensor mounting structure of claim 10, further comprising at least an additional sensor having a field of view directed to a direction different from the first direction.

15. A sensor mounting structure for a vehicle, the structure comprising:
a support arm that extends at a first end from the vehicle body; and
a sensor assembly attached to a second end of the support arm, wherein the sensor assembly comprises:
a plurality of mirrors each having a back side and a reflective side facing a first direction; and
at least one sensor; wherein
in a first configuration the at least one sensor is disposed having a field of view directed to the first direction and the back side of at least one of the plurality of mirrors disposed with the reflective side facing the first direction, and
in a second configuration the at least one of the plurality of mirrors is disposed outside of the field of view of the at least one sensor disposed having a field of view directed to the first direction.

16. The sensor mounting structure of claim 15, wherein the plurality of mirrors comprises at least a flat mirror and a convex mirror.

17. The sensor mounting structure of claim 15, wherein the at least one of the plurality of mirrors is disposed to rotate around an axis disposed through the sensor assembly from the first configuration to the second configuration.

18. The sensor mounting structure of claim 15, wherein the at least one sensor comprises a plurality of sensors, wherein in the first configuration each of the plurality of sensors is disposed having a field of view directed to the first direction and the back side of one of the plurality of mirrors disposed with the reflective side facing the first direction, and in a second configuration the plurality of mirrors is disposed outside of the field of view of the plurality of sensors disposed each having a field of view directed to the first direction.

19. The sensor mounting structure of claim 18, wherein the plurality of sensors is selected from the group of sensors consisting of an optical sensor, a light direction and ranging (LIDAR) sensor, a radio detection and ranging (RADAR) sensor, an infrared sensor, and a sonic sensor.

20. The sensor mounting structure of claim 15, further comprising at least an additional sensor having a field of view directed to a direction different from the first direction.
